(19) United States
(12) Patent Application Publication
(10) Pub. No.: US 2020/0377344 A1
(43) Pub. Date: Dec. 3, 2020

(54) GRIPPER FOR THE LIFTING OF LOADS

(71) Applicant: Idrojet S.r.l., Camporotondo Etneo (IT)

(72) Inventors: Danilo LA FERLA, Santa Maria di Licodia (IT); Manlio LA FERLA, Camporotondo Etneo (IT)

(73) Assignee: Idrojet S.r.l., Camporotondo Etneo (IT)

(21) Appl. No.: 16/604,730

(22) PCT Filed: Apr. 27, 2017
(86) PCT No.: PCT/IT2017/000088

§ 371 Date: Oct. 11, 2019

(51) Int. Cl. B66C 1/44; B66C 3/04; B66C 13/40

(52) U.S. Cl. CPC B66C 1/44; B66C 13/40; B66C 3/04

(57) ABSTRACT

A gripper device for the lifting and motion of loads. The present gripper is equipped with arms which can be actuated between a position of minimum opening and a position of maximum opening. In particular, since such arms are hinged in several points and can be moved independently, the gripper is capable to assume different intermediate configurations between the minimum opening position and the maximum opening position, by allowing to lift and/or move heavy or cumbersome loads with different shapes and sizes.

### APPLICATION FIELD

The present invention relates to the field of the machines for the lifting and motion of heavy loads and in particular it relates to a gripper device for the lifting of loads, both with compact shape and elongated shape such as cylinders or the like.

### BACKGROUND

In different industrial fields there is the need for lifting and shifting loads which, considering their own weight and/or size, cannot be moved manually. One of the methods traditionally used to move heavy or cumbersome loads consists in wrapping the load itself with cables or chains the ends thereof are anchored to a hook or similar device existing on the lifting machine. This process has considerable disadvantages since it requires the manual intervention of one or more operators for the phases of anchoring and removing the cables. This involves, on one side, a slowness in the motion procedure and, on the other side, a high risk for the safety of the involved operators.

An alternative solution which can be used for moving loads having high weight or size provides the recourse to the use of mechanically actuated grippers. Such grippers generally are characterized by the presence of arms or jaws jointed only with respect to their own central support. This configuration strongly restricts the use field of each gripper to a limited number of possible shapes and sizes of the loads to be moved. Furthermore, often the intervention of an operator is required to fix the gripper jaws or arms on the load to be moved and to control that the hooking is in the right position before proceeding with the lifting. This then involves disadvantages in terms of timing and safety of the procedure.

Moreover, mechanically actuated grippers were developed capable of hooking autonomously the load without requesting human intervention. However, whenever there is the need for moving a load with different size or shape, however still inside the limited range of possible shapes of loads dictated by the configuration itself of the gripper, it is necessary to intervene to modify the machine settings. This setting affects negatively the timing of the whole motion procedure.

The setting and control of the gripper operation generally is performed by means of a remote control connected thereto through electrical cables. Said cables can constitute an obstacle to the motion of the gripper and can be subjected to wear and rupture. Furthermore the gripper actuation usually is made possible by one or more actuators placed outside with respect to the structure of the gripper itself and connected thereto through hydraulic or pneumatic circuits. As in the previous case, such outer apparatuses can be subjected to damage, with consequent negative effects in terms of time, costs and safety.

### SUMMARY OF THE INVENTION

The object of the present invention is then to overcome the problems which can be found in the prior art and this is obtained through a gripper as defined in claim 1.

Additional features of the present invention are defined in the corresponding depending claims.

The present invention, by overcoming the problems of prior art, involves several and evident advantages.

In particular, a gripper according to the present invention, thanks to the arrangement, configuration and control of the jointed arms, can be used for moving loads with any shape.

Furthermore, the gripper according to the invention is wholly autonomous in terms of power supply and actuation, not requiring any type of connection to outer apparatuses. The control thereof is implemented remotely by means of wireless systems. The autonomous power supply and the remotely-performed control allow that the gripper can be pulled and connected to different lifting devices and it can be transported in an easier way to different working sites.

At last, the gripper does not request the human intervention to guarantee the load and/or to control the hooking thereof.

Other advantages, together with the features and use modes of the present invention, will result evident from the following detailed description of preferred embodiments thereof, shown by way of example and not for limitative purpose. In the following description the enclosed figures will be referred to, wherein:

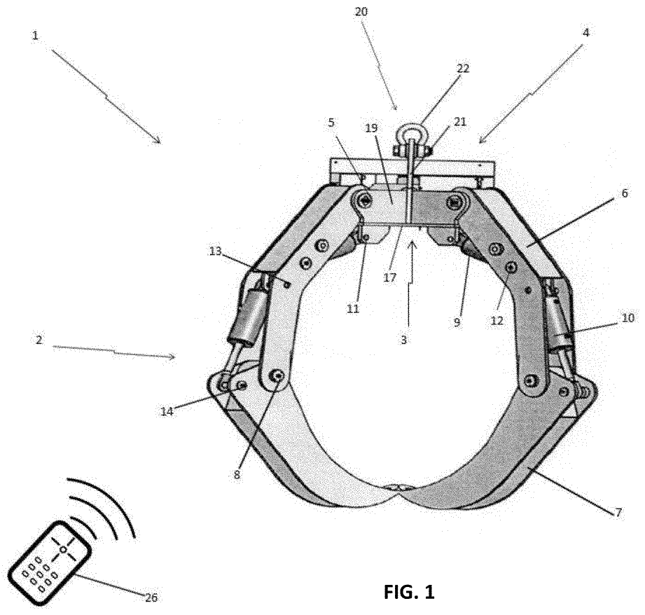

FIG. 1 represents a front view of the gripper under condition of minimum opening;

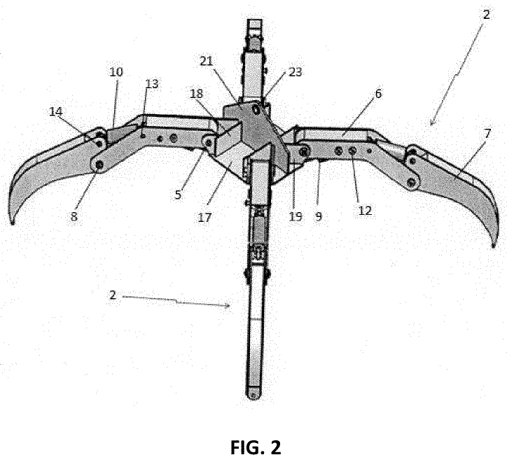

FIG. 2 represents a perspective view of the base of the central support, of the hooking element and of the arms under condition of maximum opening;

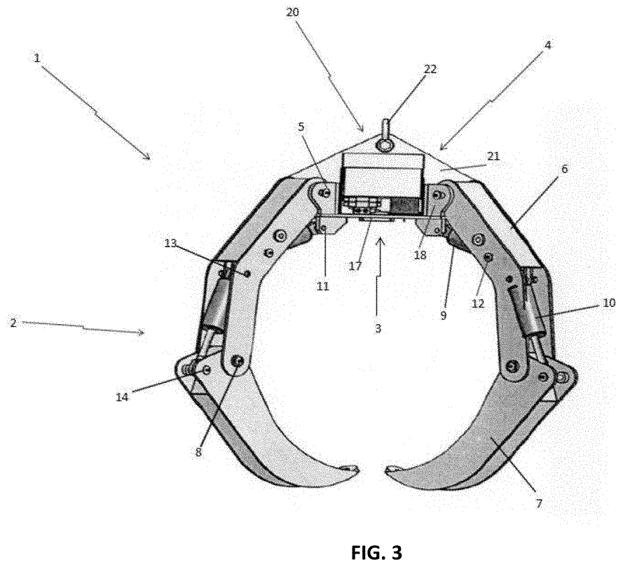

FIG. 3 represents a side view of the gripper under condition of minimum opening;

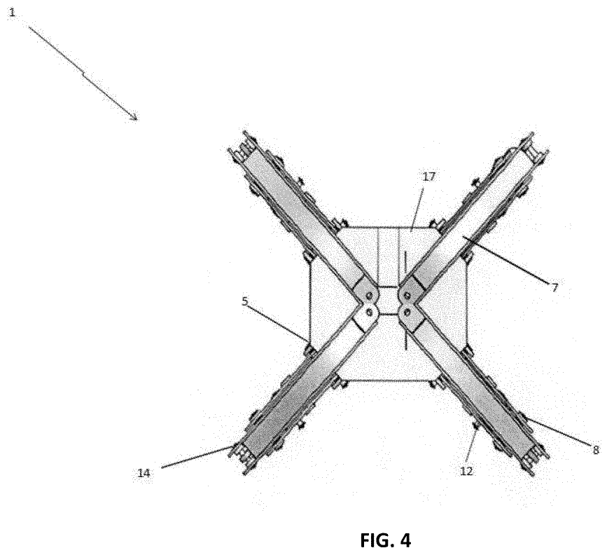

FIG. 4 represents a bottom view of the gripper under condition of minimum opening;

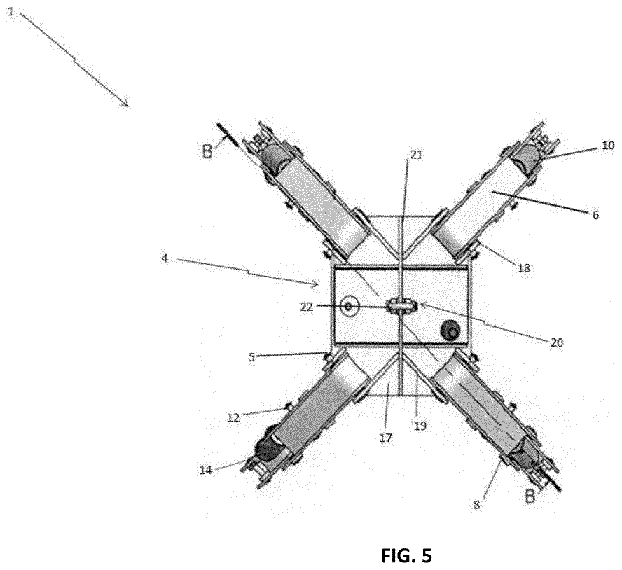

FIG. 5 represents a top view of the gripper; and

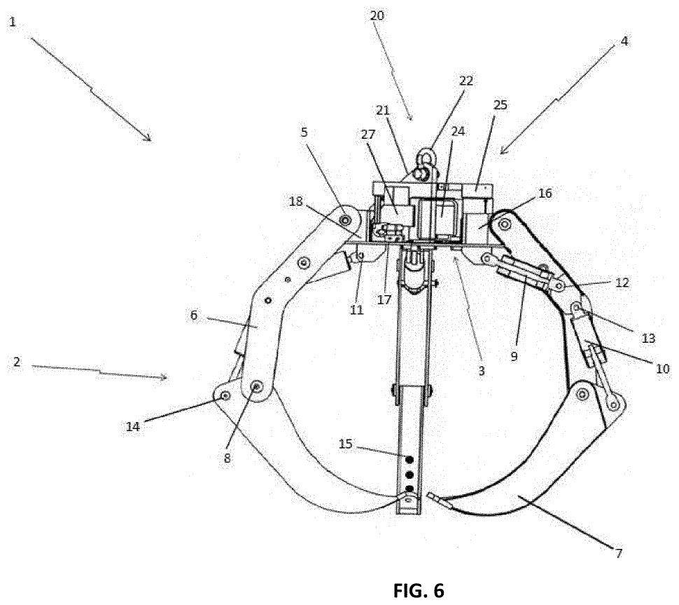

FIG. 6 represents a side view sectioned according to the axis B-B of FIG. 5.

### DETAILED DESCRIPTION OF EMBODIMENTS OF THE INVENTION

The present invention relates to a gripper for the lifting of loads, comprising a central support including a hooking group for suspending the gripper, and three or more arms, evenly spaced angularly therebetween, each one thereof has an end hinged to said central support in a first hinge point. Each one of said arms can perform a motion comprised between a position of minimum opening and a position of maximum opening around the first hinge point. Such motion is made possible by an autonomous actuation group of the arms, positioned on the central support too. The term “autonomous”, within the present invention, shows that the actuation group does not require any outer connection for the operation, neither mechanical, nor electric, nor hydraulic nor of any other type. Consequently, the gripper can be made to operate in absolutely autonomous way with respect to other means (lifter or other), in any situation, even in case there are no other power supply forms.

A possible embodiment of the invention is represented in the above mentioned figures. By referring to such figures, the gripper was designated as a whole with 1, and it comprises four arms 2, substantially orthogonal therebetween, carried by a central support 3, whereon there is further an autonomous actuation group 4 of the arms 2.

According to this embodiment, each arm 2 comprises a first portion 6, hinged to the central support 3 by means of a first hinge point 5, and a second portion 7, in turn hinged to the first portion 6 of the arm by means of a second hinge point 8.

On each arm 2, for example at the free end of the second portion 7 of the arm, there can be a sensor, or a group of sensors 15, communicating with a control unit 16 existing inside the autonomous actuation group 4. The sensor or the group of sensors 15 measures one or more parameters, such as for example distance from the load and/or pressure on the load, and it communicates them to the control unit 16 which uses them to control the motion of each single arm 2 (and/or of each single arm portion) until the occurred contact with the load to be lifted.

The selection of the type of sensors and the positioning thereof on the gripper can be considered a planning detail within the comprehension of a person skilled in the art, who could select the required components more functional to the purpose.

The motion of the arms is allowed by the presence of several actuators, each one thereof can be actuated independently from the other ones through the autonomous actuation group 4. In the specific case, the first portion 6 of the arm is moved by a first actuator 9, analogously the second portion 7 of the arm is moved by a second actuator 10. The first actuator 9 is connected to the central support 3 and to the first portion 6 of the arm respectively through the hinge points 11 and 12. In the same way, the second actuator 10 is connected to the first portion 6 of the arm and to the second portion 7 of the arm through the hinge points 13 and 14.

The structure of the arms 2, formed by two portions 6 and 7, each one thereof can be moved singularly by the actuators 9 and 10, allows the gripper 1 to assume a high number of possible configurations and then to be able to adapt to loads with different shape and size.

The adaptation to the load shape is further implemented automatically in case the gripper is provided with sensors, as above described.

Although it is to be meant that the actuators 9 and 10 can be implemented according to any (mechanical, electrical, etc.) technology, according to a preferred embodiment preferably they are of hydraulic or pneumatic type. The fluid existing inside the circuit, for example oil in case of hydraulic actuators or air in case of pneumatic actuators, and which allows the motion of the actuators 9 and 10, is fed respectively by a hydraulic pump or by a compressor 27 which, in turn, can be actuated by an endothermic engine 24. The above-mentioned actuators 9 and 10, together with the hydraulic pump or the compressor 27 and the engine 24 belong to the autonomous actuation group 4.

The autonomous actuation group 4 further comprises the control unit 16 associated to the possibly present sensors 15 and to a transceiver apparatus 25 allowing the remotely-performed control of the gripper through a wireless remote control device 26.

The central support 3 is constituted by a base 17, which is useful to support the arms 2 through two sustaining walls, respectively 18 and 19, thereon the arms 2 are hinged through the first hinge point 5. The base 17 is further equipped with a hooking group 20 which comprises a sustaining element 21 and a hook 22.

The sustaining element 21 has a slot 23, placed at the centre of gravity of the base 17, which allows to connect the hook of a lifter to the central support 3, thus allowing the lifting and motion of the gripper 1.

The present invention has been so far described with reference to preferred embodiments thereof, together with some embodiment variants. It is to be meant that each one of the variants and the technical solutions implemented in the preferred embodiments, herein described by way of example, could advantageously be combined differently therebetween, to produce other embodiments, belonging to the same inventive core and however all within the protection scope of the herebelow reported claims.

1. A gripper for the lifting of loads, comprising:
a central support including a hooking group for suspending the gripper;
three or more arms one thereof has an end hinged to said central support in a first hinge point;
an autonomous actuation group of said arms carried by said central support;
each one of said arms being able to be actuated between a position of minimum opening and a position of maximum opening around said first hinge point;
said three or more arms being evenly spaced angularly therebetween.

2. The gripper according to claim 1, comprising four arms.

3. The gripper according to claim 1, wherein each one of said arms comprises two arm portions hinged therebetween in a second hinge point.

4. The gripper according to claim 3, wherein for each arm, said two portions are hinged therebetween at the respective ends thereof.

5. The gripper according to claim 1, wherein said actuation group comprises at least a first hydraulic or pneumatic actuator for each one of said arms, for the actuation around said first hinge point.

6. The gripper according to claim 3, wherein said actuation group comprises a second hydraulic or pneumatic actuator for each one of said arms, for the actuation around said second hinge point.

7. The gripper according to claim 5, wherein said actuation group comprises a hydraulic pump or a compressor for the power supply of said hydraulic or pneumatic actuators, and an endothermic engine for actuating said hydraulic pump or said compressor.

8. The gripper according to claim 1, wherein said actuation group control unit associated to a transceiver apparatus to allow to control remotely the gripper.

9. The gripper according to claim 4, wherein said transceiver apparatus is of wireless type and it comprises a remote control device.

10. The gripper according to claim 3, wherein on the second portion of each arm there is a sensor or group of sensors associated to the control unit, by allowing an autonomous and independent motion and control of each arm.
